(19) United States
(12) Patent Application Publication
(10) Pub. No.: US 2007/0218021 A1
(43) Pub. Date: Sep. 20, 2007

(54) NON-IRRITATING SUNSCREEN COMPOSITION

(75) Inventor: Richard Wells, Salt Lake City, UT (US)

Correspondence Address: KELLY LOWRY & KELLEY, LLP, 6320 CANOGA AVENUE, SUITE 1650, WOODLAND HILLS, CA, 91367, US

(73) Assignee: AZUR SKIN INTERNATIONAL, Hidden Hills, CA (US)

(21) Appl. No.: 11/687,830

(22) Filed: Mar. 19, 2007

Related U.S. Application Data
(60) Provisional application No. 60/767,336, filed on Mar. 20, 2006.

(51) Int. Cl. A61Q 17/04

(52) U.S. Cl. 424/59

(57) ABSTRACT

An oil in water emulsion based sunscreen composition incorporating inorganic sunscreen agents is provided. The sunscreen composition is non-irritating to the eyes and mucous membranes.

### BACKGROUND OF THE INVENTION

The present invention generally relates to sunscreen compositions. More particularly, the present invention relates to a sunscreen composition which is non-irritating to the eyes.

The use of sunscreen over exposed areas of one's body to prevent overexposure and skin damage, such as skin cancer or sunburn, is well-known. It is widely accepted that overexposure to the sun can not only cause skin cancer, but unsightly blotches, skin imperfections, and premature wrinkling. Thus, protective sunscreens are more popular than ever.

A person's face is nearly always exposed to the sun while outdoors and thus requires sunscreen. A problem arises when applying the sunscreen around the eyes as a small amount can be inadvertently rubbed into the eyes or flow into the eyes due to sweating, causing irritation of the eyes. This is particularly the case when applying sunscreen to small children who open their eyes or move about when the sunscreen is being applied and whose tolerance to the irritation is lower than that of an adult. Also, it is common knowledge that wrinkles form in the face and eye area, at least in part, due to sun exposure. Individuals, particularly women, have been reluctant or unable to apply existing sunscreens near their eyes without stinging or burning the eye. As a result, despite their strong desire to prevent premature aging, women have been unable to protect the area most vulnerable to premature aging without the risk of stinging or burning the eye. In some individuals, it is not only the movement of the sunscreen into the eye, such as when one rubs the eye area or due to sweat moving the sunscreen into the eye, but rather it is the proximity of the sunscreen to the eye which can cause an adverse reaction, possibly due to the vapors emanating from the sunscreen or the sunscreen passing through the skin and into body tissues.

Surfactant systems that are mild to hair, skin, eyes and ocular mucosa are known, such as that found in “NO MORE TEARS®” baby shampoo available from Johnson &Johnson Consumer Companies, Inc., who developed it to lessen eye sting during the shampoo process. U.S. Pat. No. 6,642,198 discloses a clear cleansing detergent which does not cause significant irritation to the skin and eyes by using polyol glycol thickeners.

U.S. Pat. No. 5,876,699 discloses a sun block composition suitable for sensitive skin areas, such as around the eyes, which contains an emulsion of micronized titanium dioxide and an organic chemical sunscreen agent encapsulated in transparent plastic spheres. Others, such as U.S. Pat. No. 5,573,755, disclose the use of insoluble ingredients in a sunscreen composition or use of thickeners which do not move from the skin and into the eyes.

However, there is not known a sunscreen composition which is of regular viscosity and thickness so as to be readily applied on one's skin in normal fashion, but which is non-irritating to the eye. Accordingly, there is a continuing need for such a sunscreen.

### SUMMARY OF THE INVENTION

The present invention resides in a sunscreen composition which is of regular viscosity and thickness so as to be readily applied to ones skin in normal fashion, but which is non-irritating to the eyes. The composition comprises an oil in water emulsion with inorganic sunscreen agents and selected ingredients which are oil-soluble and have gentle and non-irritating characteristics. As such, the sunscreen composition of the present invention does not irritate mucous membranes, such as the eyes.

The oil in water emulsion sunscreen composition of the present invention generally comprises at least one inorganic sunscreen agent, selected from the group consisting of titanium dioxide, zinc oxide and the mixtures thereof. The composition further comprises an emulsifier, at least one emollient, a film forming/water proofing agent, water, an anti-inflammatory agent, a stabilizer, and a preservative.

In a particularly preferred embodiment, the at least one inorganic sunscreen agent comprises a titanium dioxide mixture as well as a zinc oxide mixture. The titanium dioxide mixture consists essentially of C12-15 alkyl benzoate, titanium dioxide, polyhydroxystearic acid, and Itt/Tcs crosspolymer. The zinc oxide mixture consists essentially of alkyl benzoate, zinc oxide, polyhydroxystearic acid, and triethoxy caprylylsilane.

The emulsifier typically consists of sorbitan olivate. The at least one emollient is typically selected from the group consisting of octyldodecanol, cyclopentasiloxane, glycerin and mixtures thereof.

The film forming/water proofing agent typically comprises VP/hexadeacene copolymer. The anti-inflammatory typically comprises dipotassium glycyrrhizinate. Preferably, the sunscreen composition also includes a soothing agent, such as aloe barbadensis leaf juice.

Typically, the water used is deionized water. The stabilizer comprises magnesium sulfate heptahydrate. The preservative typically consists essentially of Phenoxyethanol, Capryl Glycolic, Ethylhexylglycerin, and Hexylene Glycol.

In a particularly preferred embodiment, the composition includes at least one oil-soluble vitamin having anti-oxidant properties. The at least one oil soluble vitamin is selected from the group consisting of tetrahexyldecyl ascorbate, retinyl palmitate, tocopheryl acetate, and mixtures thereof.

Other features and advantages of the present invention will become apparent from the following more detailed description, taken in conjunction with the accompanying drawings, which illustrate, by way of example, the principles of the invention.

### DETAILED DESCRIPTION OF THE PREFERRED EMBODIMENTS

The present invention resides in a sunscreen composition having an oil in water emulsion, with a rigorous selection of ingredients for their gentle and non-irritating characteristics so as not to sting or irritate the eye area and with any water soluble material selected for their non-sting/irritation potential in the eye area, and with the selection of material that are oil-soluble and non-water soluble for any material which would potentially sting or otherwise irritate the eye area, so as to render them non-irritating to the eye. Traditional sunscreens burn or sting the eyes because they use water soluble sunscreens and other harsh ingredients that burn the eyes and/or sensitive skin. The sunscreen composition of the present invention does not irritate the eyes because it uses inorganic sunscreen compounds, such as titanium dioxide and zinc oxide. Also, there is a rigorous selection of all the other ingredients for their gentleness and non-stinging properties, and oil-soluble properties, thus non-water soluble ingredients are selected so that they are not otherwise soluble in and sting or irritate the eye area. As will be more fully described herein, the sunscreen composition of the present invention also incorporates anti-inflammatory and soothing ingredients which further lessens any stinging or irritation if the sunscreen enters the eye.

The sunscreen composition of the present invention has a wide spectrum of UVA and UVB protection. Moreover, the composition preferably incorporates powerful vitamin anti-oxidants and soothing ingredients and moisturizers to benefit the skin, and prevent it from drying out in the sun.

The present invention can be created in a range of SPF (Sun Protection Factor). As is known in the art, if one begins to tan or burn after ten minutes, an SPF of 15 extends your protection 15 times longer or that you should not tan or burn for at least 150 minutes. Essentially, the higher the SPF, the better the barrier between the sunlight and the skin. For purposes of example, compositions having an SPF of 40, which are very protective, will be described. Of course, it will be appreciated by those skilled in the art that sunscreen compositions having different SPF can be created, such as by altering the amount of titanium dioxide and/or zinc oxide sunscreen agents, which will result in altering somewhat the percentages of the remaining ingredients, such as the water.

The SPF-40 composition generally comprises first combining and mixing at an elevated temperature an oil-water emulsifier, at least one emollient, and a sunscreen compound. Preferably, oil-based anti-oxidant vitamins are also added for the benefit of the wearer's skin. Also, preferably a film-forming/water-proofing agent is added at this step.

In a particularly preferred embodiment, the following ingredients, referred to herein as Sequence No. 1, are combined, heated to 80° C., and mixed until uniform. The Sequence No. 1 ingredients are added by percentage weight, as follows:

7.50% Sorbitan Olivate (sold under the trade name Olivem 900);
6.00% Octyldodecanol (sold under the trade name Eutanol G);
8.00% Cyclopentasiloxane (sold under the trade name Botanisil CP-33);
1.00% VP/Hexadecene Copolymer (sold under the trade name Ganex V-216);
0.10% Tetrahexyldecyl Ascorbate (or Vitamin C, sold under the trade name BV-OSC);
0.02% Retinyl Palmitate (or Vitamin A, sold under the trade name Vit. A Palmitate);
16.40% inorganic sunscreen compound. In the particularly preferred embodiment, this is a titanium dioxide mixture consisting of: C12-15 Alkyl Benzoate, Titanium Dioxide, Polyhydroxystearic Acid, and Itt/Tcs Crosspolymer (sold under the trade name TNP55VTTS); and
0.99% Tocopheryl Acetate (or Vitamin E, sold under the trade name Vit. E Acetate).

After the Sequence No. 1 ingredients have been combined, heated, and mixed as indicated above, in a particularly preferred embodiment, 6.00% of a second sunscreen compound is added. This compound is preferably a zinc oxide inorganic sunscreen agent mixture, typically consisting of Alkyl Benzoate, Zinc Oxide, Polyhydroxystearic Acid, Triethoxy Caprylylsilane (sold under the trade name TPN50ZSI). This is typically added to the Sequence No. 1 mixture with homomixing.

Thus, the combined mixture of Sequence No. 1 and Sequence No. 2 (the second sunscreen compound) consists of the necessary oil-water emulsifiers, emollients and moisturizers, Vitamins A, C and E, and sunscreen compounds. It will be appreciated by those skilled in the art that different combinations of emulsifiers and emollients can be used, although the emulsifiers and emollients listed above have been selected as having very low irritation to the eyes. Of course, the Vitamins A, C and E, which are oil-based or oil-soluble, provide anti-oxidant and health benefits to the skin of the wearer of the sunscreen of the present invention. The Ganex V-216 ingredient provides a water resistance and rub resistance to the sunscreen of the present invention. This compound is a film former or water proofing agent.

A separate mixture of ingredients is also created, referred to herein as Sequence No. 3. which is combined, separately from Sequence Nos. 1 and 2. Sequence No. 3 consists of a diluent, a stabilizer and various soothing, anti-inflammatory, and softening or humectant agents, as well as preservatives. In a particularly preferred embodiment, the Sequence No. 3 mixture consists of the following ingredients:
47.45% Deionized Water;
4.00% Glycerin;
0.50% Aloe Barbadensis Leaf Juice (sold under the trade name Aloe Vera 104);
0.10% Dipotassium Glycyrrhizinate (sold under the trade name Net-DG);
0.70% Magnesium Sulfate Heptahydate; and
1.20% Preservatives such as, for example, a mixture of Phenoxyethanol, Capryl Glycolic, Ethylhexylglycerin, and Hexylene Glycol (collectively sold under the trade name Botanistat PF-64), although other preservative systems could be used, as well.

It will be appreciated by those skilled in the art that Glycerin serves multiple purposes, such as a solvent and emollient, and particularly serves as a humectant which serves to moisten and soften the skin. Aloe Vera 104 is a soothing agent, and Net-DG is an anti-inflammatory, which further reduces any irritation in the event that the sunscreen composition of the present invention enters the eye. These ingredients are mixed in a side kettle and heated to 80° C.

Very slowly, the Sequence No. 3 mixture is added to the Sequence Nos. 1 and 2 mixture, with homomixing. A switch is made to propeller mixing, and the combined Sequence Nos. 1, 2 and 3 mixture is cooled to 42° C.

Once the combined mixture reaches 42° C., additional optional ingredients can be added to the combined batch with medium speed propeller mixing. For example, Tangerine Essence (trade name Tangerine Essence 273690) can be added in a relatively small amount (0.04%) to add a pleasant scent to the composition. Other chemicals, such as acne preventing plant extracts or the like can be added in the final mixing step, as well, if deemed desirable. These ingredients give the sunscreen composition enhanced properties, such as a pleasant smell, which are desirable by the end consumer.

It will be appreciated by those skilled in the art that the resulting sunscreen composition described above is non-irritating to the eye. This is due to many factors, including the use of inorganic sunscreen compounds, as indicated above. Moreover, the sunscreen composition of the present invention includes soothing agents and anti-inflammatories which further lessen the irritation in the event that the sunscreen enters the eye. Moreover, the ingredients selected for use in the composition of the present invention are oil-soluble, or have a gentle and non-stinging properties. In addition to the non-irritating properties, the sunscreen composition of the present invention also includes compounds which are beneficial to the skin, such as moisturizers, vitamins, and humectants.

Although several embodiments have been described in some detail for purposes of illustration, various modifications may be made without departing from the scope and spirit of the invention. Accordingly, the invention is not to be limited, except as by the appended claims.

What is claimed is:

1. An oil in water emulsion sunscreen composition, comprising:
at least one inorganic sunscreen agent, selected from the group consisting of titanium dioxide, zinc oxide and mixtures thereof;
an emulsifier;
at least one emollient;
a film forming/waterproofing agent;
water;
an anti-inflammatory agent;
a stabilizer; and
a preservative.

2. The sunscreen composition of claim 1, wherein the at least one inorganic sunscreen agent comprises a titanium dioxide mixture consisting essentially of C12-15 alkyl benzoate, titanium dioxide, polyhydroxystearic acid, and Itt/Tcs crosspolymer.

3. The sunscreen composition of claim 2, wherein the inorganic sunscreen agent further comprises a zinc oxide mixture.

4. The sunscreen composition of claim 3, wherein the zinc oxide mixture consists essentially of alkyl benzoate, zinc oxide, polyhydroxystearic acid, and triethoxy caprylylsilane.

5. The sunscreen composition of claim 1, wherein the emulsifier consists of sorbitan olivate.

6. The sunscreen composition of claim 1, wherein the at least one emollient is selected from the group consisting of octyldodecanol, cyclopentasiloxane, glycerin and mixtures thereof.

7. The sunscreen composition of claim 1, wherein the film forming/waterproofing agent comprises VP/hexadeacene copolymer.

8. The sunscreen composition of claim 1, including a soothing agent comprising aloe barbadensis leaf juice.

9. The sunscreen composition of claim 1, wherein the anti-inflammatory comprises dipotassium glycyrrhizinate.

10. The sunscreen composition of claim 1, wherein the stabilizer comprises magnesium sulfate heptahydrate.

11. The sunscreen composition of claim 1, wherein the preservative consists essentially of Phenoxyethanol, Capryl Glycolic, Ethylhexylglycerin, and Hexylene Glycol.

12. The sunscreen composition of claim 1, including at least one oil soluble vitamin having anti-oxidant properties.

13. The sunscreen composition of claim 12, wherein the at least one oil soluble vitamin is selected from the group consisting of tetrahexyldecyl ascorbate, retinyl palmitate, tocopheryl acetate, and mixtures thereof.

14. An oil in water emulsion sunscreen composition, comprising:
a titanium dioxide sunscreen agent mixture consisting essentially of C12-15 alkyl benzoate, titanium dioxide, polyhydroxystearic acid, and Itt/Tcs crosspolymer;
a zinc oxide mixture consisting essentially of alkyl benzoate, zinc oxide, polyhydroxystearic acid, and triethoxy caprylylsilane;
an emulsifier;
at least one oil soluble emollient;
an oil soluble film forming/waterproofing agent;
water;
at least one oil soluble vitamin having anti-oxidant properties;
an oil soluble anti-inflammatory agent;
a stabilizer; and
an oil soluble preservative.

15. The sunscreen composition of claim 14, wherein the emulsifier consists essentially of sorbitan olivate.

16. The sunscreen composition of claim 14, wherein the film forming/waterproofing agent comprises VP/hexadeacene copolymer.

17. The sunscreen composition of claim 14, wherein the at least one emollient is selected from the group consisting essentially of octyldodecanol, cyclopentasiloxane, glycerin and mixtures thereof.

18. The sunscreen composition of claim 14, including a soothing agent comprising aloe barbadensis leaf juice.

19. The sunscreen composition of claim 14, wherein the anti-inflammatory consists essentially of dipotassium glycyrrhizinate.

20. The sunscreen composition of claim 14, wherein the stabilizer consists essentially of magnesium sulfate heptahydrate.

21. The sunscreen composition of claim 14, wherein the preservative consists essentially of Phenoxyethanol, Capryl Glycolic, Ethylhexylglycerin, and Hexylene Glycol.

22. The sunscreen composition of claim 14, wherein the at least one oil soluble vitamin is selected from the group consisting essentially of tetrahexyldecyl ascorbate, retinyl palmitate, tocopheryl acetate, and mixtures thereof.

23. An oil in water emulsion sunscreen composition, comprising:
a titanium dioxide sunscreen agent mixture consisting essentially of C12-15 alkyl benzoate, titanium dioxide, polyhydroxystearic acid, and Itt/Tcs crosspolymer;
a zinc oxide mixture consisting essentially of alkyl benzoate, zinc oxide, polyhydroxystearic acid, and triethoxy caprylylsilane;
an emulsifier consisting essentially of sorbitan olivate;
at least one oil soluble emollient selected from the group consisting essentially of octyldodecanol, cyclopentasiloxane, glycerin and mixtures thereof;
a film forming/waterproofing agent consisting essentially of VP/hexadecene copolymer;
deionized water;
at least one oil soluble vitamin having anti-oxidant properties selected from the group consisting essentially of tetrahexyldecyl ascorbate, retinyl palmitate, tocopheryl acetate, and mixtures thereof;
an anti-inflammatory agent consisting essentially of dipotassium glycyrrhizinate;
a stabilizer; and
a preservative.

24. The sunscreen composition of claim 23, including a soothing agent comprising aloe barbadensis leaf juice.

25. The sunscreen composition of claim 23, wherein the stabilizer consists essentially of magnesium sulfate heptahydrate.

26. The sunscreen composition of claim 23, wherein the preservative consists essentially of Phenoxyethanol, Capryl Glycolic, Ethylhexylglycerin, and Hexylene Glycol.
